(19) United States
(12) Patent Application Publication
(10) Pub. No.: US 2005/0198107 A1
(43) Pub. Date: Sep. 8, 2005

(54) Systems and methods for queuing order notification

(75) Inventors: Johann Heinrich Cuhls, Singapore (SG); Craig William Fellenstein, Brookfield, CT (US); Rick Allen Hamilton II, Charlottesville, VA (US); James Wesley Seaman, Falls Church, VA (US)

Correspondence Address: Barry S. Newberger, 1201 Main Street, P.O. Box 50784, Dallas, TX, 75250-0784, US

(73) Assignee: International Business Machines Corporation, Armonk, NY (US)

(21) Appl. No.: 10/759,933

(22) Filed: Jan. 16, 2004

(51) Int. Cl. H04M 3/00; H04M 5/00; G06F 15/16

(52) U.S. Cl. 709/201; 379/265.01; 186/35

(57) ABSTRACT

A mechanism for providing patrons waiting in a service provider's queue with information as to their status in the queue are provided. While a patron is in the queue, at time intervals specified which may be user selectable, an estimate of the time remaining is calculated based on the patron's current position in the queue. The estimated time and/or other queue order information may be transmitted to the patron using the patron's own device, such as a personal digital assistant (PDA), cell phone, etc. When the patron reaches the head of the queue, a notification may be similarly transmitted. Additionally, the party may be provided with the option to sacrifice its position in the queue for a later position.

### TECHNICAL FIELD

The present invention is related to data processing systems for monitoring a queue, and in particular for monitoring human queues and providing queue order feedback to the parties in the queue.

### BACKGROUND INFORMATION

Human queues are commonplace. Queues can regularly be observed wherever services are provided locally at a provider facility, for example, restaurants, governmental service providers, amusement and theme parks, physicians and dentists offices and the like. The queued party or, equivalently, a patron may be given a paper ticket indicting their position in the queue, and the number of the party currently being served displayed by an electronic or mechanical means to indicate the head of the queue. Other notification means include audible announcements, and hand-carried devices provided to the patron that provide a visual (typically, flashing lights) and a tactal (typically, vibration) alert when the patron has reached the head of the queue. All of these require that the queued patron remain at the cite of the service provider, regardless of the length of the queue, or risk losing his or her position. Additionally, the queued party typically has little indication of their progress through the queue or of the time remaining until they may reach the head of the queue. Commonly, the parties recourse is to return to the service provider's employee maintaining the queue and inquire. In a lengthy queue, the party may repeat this inquiry several times before ultimately being served.

Thus, there is a need in the art for mechanisms to allow such parties to monitor their position in the queue, and selectively receive estimates as to the time remaining until it will be served. Additionally, there is a further need for providing this information remotely, whereby the patron may, if the queue is long, elect to leave the service provider's locale to do other tasks, for example, while monitoring progress through the queue.

### SUMMARY OF THE INVENTION

The aforementioned needs are addressed by the present invention. Accordingly, there is provided in one embodiment of the present invention a method for queue order notification. The method includes determining a current position of a patron seeking services from a provider in a queue. A current estimated time remaining for the patron is determined using the current position of the patron and a selected set of historical data. Queue-order information, which may include the estimated time, is transmitted to the patron using a preselected communication channel. If the preselected communication channel is a duplex channel, the queue-order information constitutes a set of patron-selectable queue-order information, in which the set includes the estimated time remaining and the current position of the patron in the queue.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates and architecture for queuing order notification in accordance with the present principles;

FIGS. 2A-2C illustrate, in flowchart form, a methodology for providing queue order notification in accordance with an embodiment of the present invention; and

FIG. 3 illustrates, in block diagram form, a data processing system which may be used in conjunction with the methodologies incorporating the present inventive principles.

### DETAILED DESCRIPTION

Mechanisms for providing patrons waiting in a service provider's queue with information as to their status in the queue are provided. While a patron is in the queue, at time intervals specified which may be user selectable, an estimate of the time remaining is calculated based on the patron's current position in the queue. The estimated time and/or other queue order information may be transmitted to the patron using the patron's own device, such as a personal digital assistant (PDA), cell phone, etc. When the patron reaches the head of the queue, a notification may be similarly transmitted. Additionally, the party may be provided with the option to sacrifice its position in the queue for a later position.

In the following description, numerous specific details are set forth to provide a thorough understanding of the present invention. For example, particular messaging protocols may be referred to, however, it would be recognized by those of ordinary skill in the art that the present invention may be practiced without such specific details, and in other instances, well-known circuits have been shown in block diagram form, in order not to obscure the present invention in unnecessary detail. Refer now to the drawings wherein depicted elements are not necessarily shown to scale and wherein like or similar elements are designated by the same reference numeral through the several views.

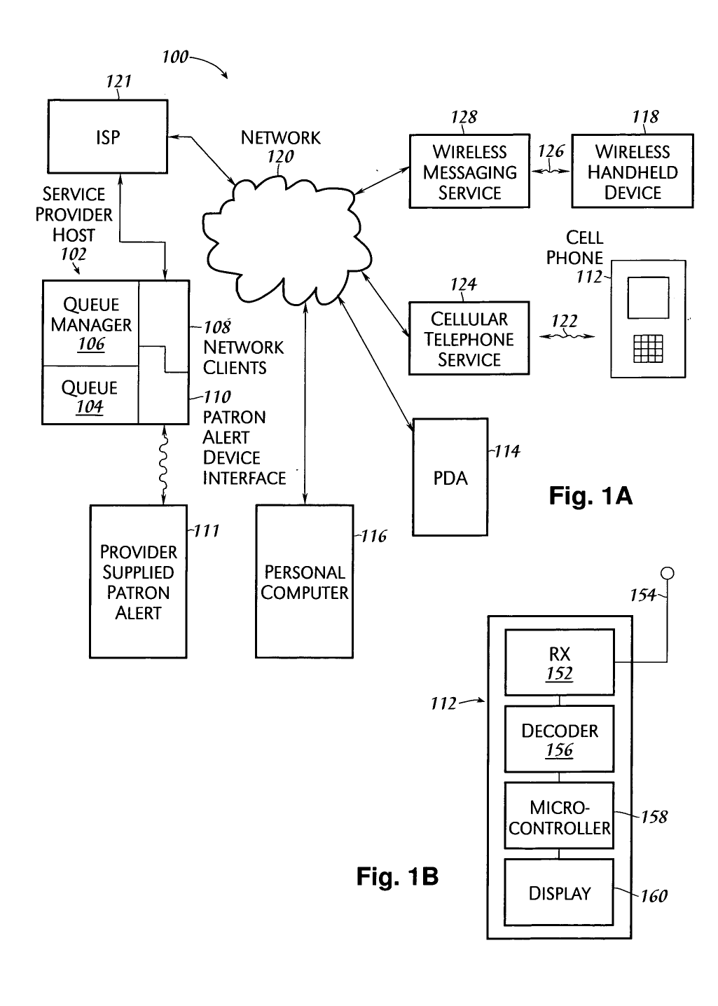

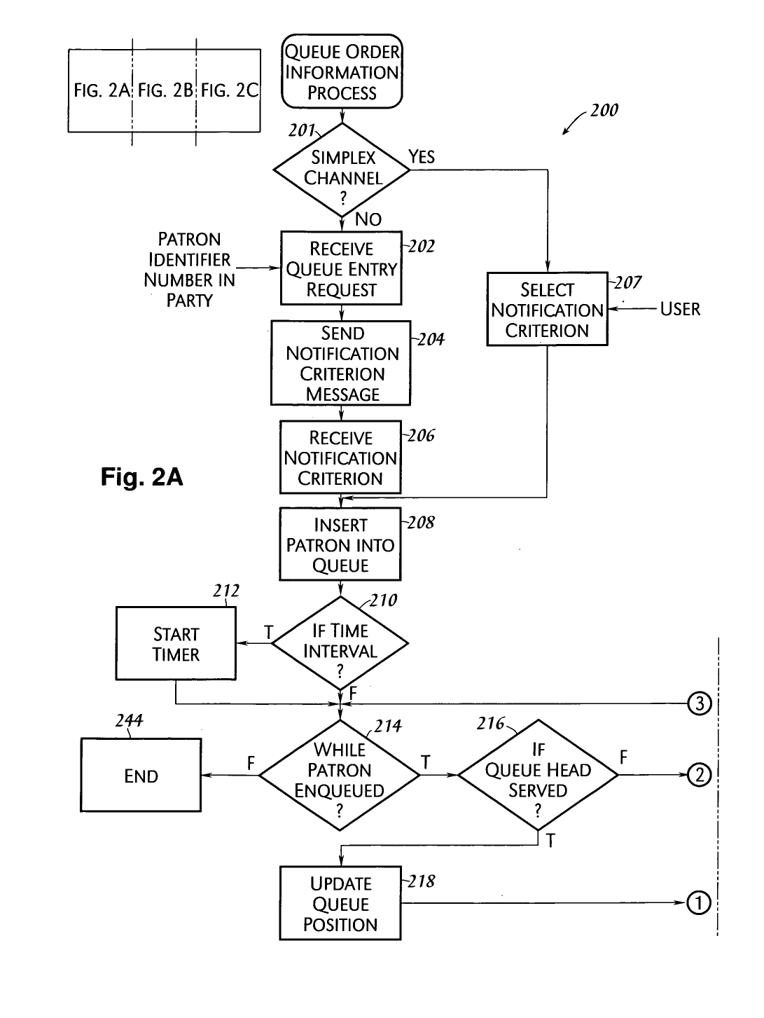

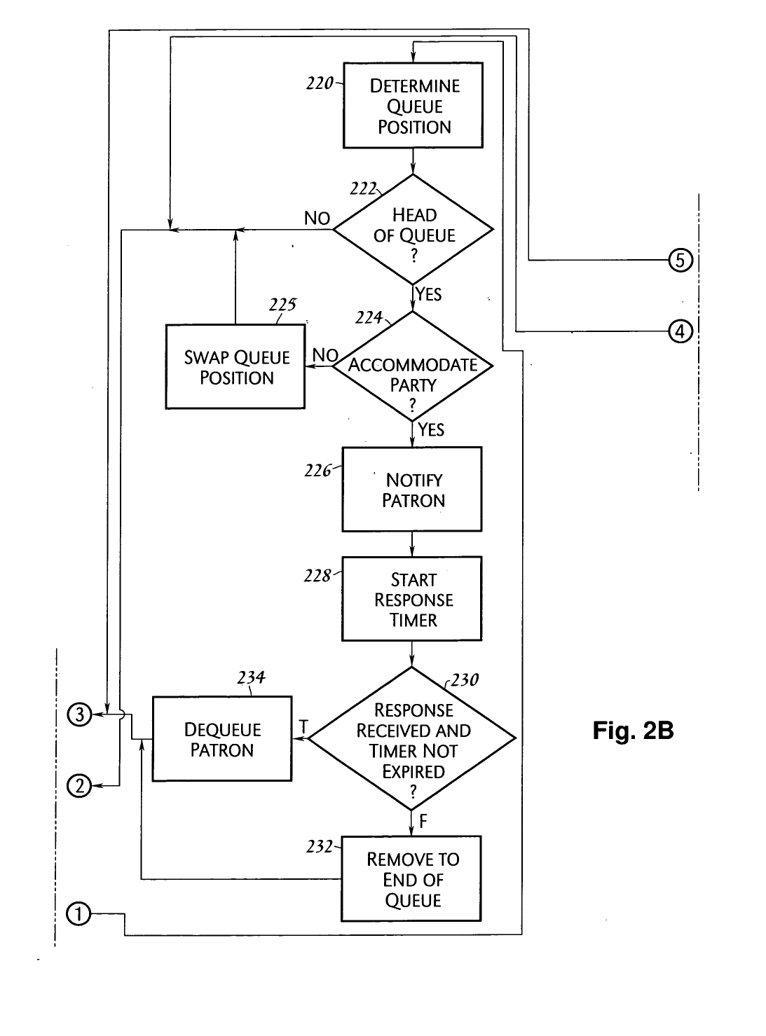

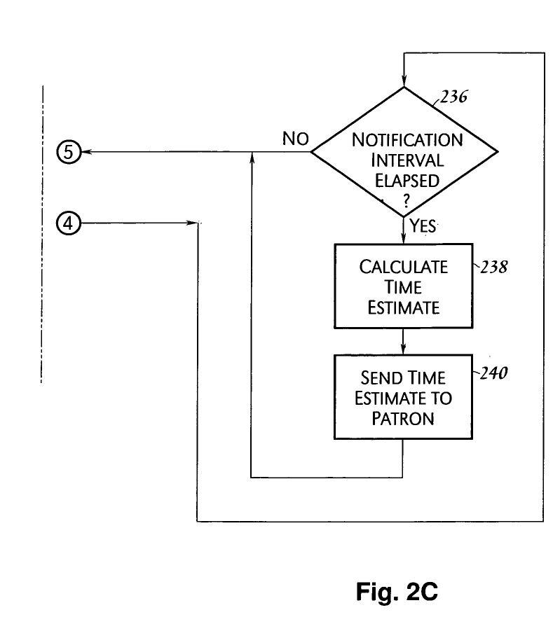

Refer now to FIG. 1 illustrating an architectural block diagram of a system which may be used in conjunction with the methodologies of the present invention for queuing order notification. As previously discussed, human queues are common place particularly in association with providers of services such as restaurants, governmental service providers, physician's offices, theme parks and other businesses, represented in the architecture of FIG. 1 by service provider host 102. The operations for providing queue order information to patrons in accordance with the present invention, described in conjunction with FIGS. 2A-2C below, may at least in part be performed by service provider host 102. Service provider host 102 maintains a queue 104 of patrons waiting to be served, as the circumstances demand. Typically, depending on the particular business enterprise, the demand for the particular services vary over time during the business day. It is well known, for example, that restaurants have peak demand during the typical meal time hours and, moreover, these demand peaks may have additional variations depending on the day of the week or seasonal variations, for example.

Queue 104 may be managed by a queue manager 106 which provides for the entry of patrons into the queue, and the deletion thereof as well as updating patron's position in the queue. Queue manager 106 may be software running on a conventional personal computer or work station. Network clients 108 interface the service provider host 102 with a network 120. Additionally, a provider supplied patron alert device 111, may be interfaced with the queue merger 106 via patron alert device interface 110. As previously discussed, service providers presently may provide patrons with a portable device that alerts the patron, by mechanical and optical stimuli, that the patron can be served. A provider supplied device in accordance with the present inventive principles, illustrated as provider supplied device 111 may be used to inform the patron of his or her position in the queue as described hereinbelow.

Additionally, the present inventive principles may be used in conjunction with a multiplicity of personal data processing devices including cellular telephone (“cell phone”) 112, personal digital assistance (PDA) 114, personal computer 116 and wireless hand-held messaging/e-mail device 118. (Although referred to herein in the singular, it would be understood by persons of ordinary skill in the art that a plurality of such devices would typically be represented in a physical realization of architecture 100.) Each of these may be coupled to the service provider host via network 120 and a corresponding service that provides the interface between a respective wireless device and the network. (Note, for the purposes herein, network, such as network 120 may be understood to refer, generically, to one or more interconnected networks, or the Internet itself.) Additionally, the service provider host 102 may be connected to a network via an intermediary, such as an Internet Service Provider (ISP 121), as would be understood by those of ordinary skill in the art. Likewise, PDA 114 and personal computer 116 may similarly be connected to the network.

Network clients 108 provide the mechanism by which queue manager 106 communicates with network connected users, represented, schematically in architecture 100 by cell phone 112, PDA 114, personal computer 116 and wireless hand-held device 118. Hardware level interface (commonly referred to as the physical layer) that connects service provider host 102 to network 120, typically via an ISP, such as ISP 121, as previously described, would be understood to be commercially available communication links such as a Digital Subscriber Line (DSL), cable modem or similar technology. Network clients 108 may include several applications that may be used to intermediate communication over the network between queue manager 106 and patrons connected by these aforementioned patron devices. Network clients 108 may include an e-mail client which may be used to pass queuing order information to patrons using wireless hand-held devices, such as wireless hand-held device 118, or to patrons using a PDA such as PDA 114 or personal computer 116. Such information may be provided in accordance with the methodology described below in conjunction with FIGS. 2A-2C, which may be performed, at least in part, by queue manager 106. The information may be generated by queue manager 106 and passed to the e-mail client via interprocess communications in accordance with the particular platform (i.e. operating system) deployed on service provider host 102. For example, previously noted, queue manager 106 may include a spreadsheet application that maintains queue 104, augmented by a macro or other script which performs the operations described in conjunction with the methodology in FIG. 2. For example, commercially available spreadsheet applications, such as' Microsoft Excel, may be scripted (using Visual Basic, for example). Alternatively, cross-platform Perl-based spreadsheet scripts, such as WriteExcel may be used in conjunction with the methodologies of the present invention. (WriteExcel may be found at the Comprehensive Perl Archive Network (CPAN) which is a center repository for Perl software (www.cpan.org.). (Artisans of ordinary skill would recognize that Perl is a cross-platform general-purpose scripting language.) Additionally, network clients may include a web client, which may be a commercial browser, or alternatively, a HTML parser, which may be used to provide queuing order information to patrons using cell phones with messaging service capability. (For the purposes herein, it may be assumed that cell phone 112 has such capability.) Cellular telephone service providers (such as AT&T Sprint, Cingular and Verizon, for example) provide a web page interface via which a message may be sent to a subscriber using the subscriber's cell phone number.

Also, a web interface may be provided to patrons. A web page may include form input to receive data (as discussed below) from patrons and may be provided by a hosting service via ISP 121.

Network connectivity is provided to cellular telephone and wireless digital messaging service subscribers, schematically represented by cell phone 112 and wireless digital messaging device 118 in FIG. 1, by the respective service providers. Thus, cell phone 112 may be provided with network connectivity via a radio communication channel 122 over which messages are transmitted between the phone and cellular service provider 124 which is connected to network 120. Similarly, wireless messaging device 118 communicates over a radio communication channel 126 with wireless messaging service provider 128, which provides connectivity to network 120.

Additionally, as previously described, a provider supplied patron alert may be used to provide queuing order information to patrons. Typically, these will be used in the vicinity of the service provider's establishment. A radio frequency link may be used to communicate between the service provider host 102 and the provider supplied patron alert 111. This link may be mediated via patron alert device interface 110. A block diagram illustrating a provider supplied patron alert 111 in further detail is illustrated in FIG. 1B. This device may include a radio frequency receiver coupled to an antenna 154. Note that the radio frequency link may operate in a portion of the radio frequencies spectrum commonly used for unlicensed intentional radiators operating under Part 15 of the Federal Communications Commission (FCC) rules. One commonly employed frequency is about 433 Megahertz. Another is about 916 Megahertz. Decoder 156 decodes a digital signal output output by receiver 152. The digital signal may include a plurality of bits constituting one portion representing an address, and a second portion representing data. The address portion of the signal designates the particular provider supplied patron alert that for which the data is intended. In this way, the individual patrons possessing the device may be selectively alerted. The data portion may represent the estimated time remaining for that patron in the queue, for example. Commercially available devices such as the HT12F decoder from the Holtek Semiconductors, Inc., Taiwan, may be adapted for such use. A microcontroller 158 may be used to drive a display, such as an LCD or LED display 160, converting the digital values embedded in the data from decoder 156 to a format suitable by the display. An eight-bit commercially available microcontroller could be sufficient to perform the translation, and the programming thereof would be within the skill of persons of ordinary skill in the art. An exemplary eight-bit microcontroller that may be used is a 16F84 microcontroller from Microchip Technology, Inc., Chandler, Ariz.

Alert device interface 110 may receive the queue order information, such as a patron's estimated time remaining in the queue from queue manager 106, and encode that value into the composit address and data signal. A Holtek HT12E encoder, which is the companion to the aforementioned HT12F decoder may be used in conjunction with a Part 15—compliant transmitter to communicate the address and data signal to the corresponding provider supplied patron alert 111. Note that any commercially available Part 15—compliant transmitter and a receiver capable of receiving a digital pulse modulation signal may be used. (Transmitter and receiver modules such as the TX443 (433 Megahertz) or TX916 (916 Megahertz) and the corresponding receivers, RX433 and RX916, from Ramsey Electronics, Inc., Victor, N.Y. are exemplary devices.

Refer now to FIG. 2, illustrating in flow chart form, queue order information notification process 200 in accordance with an embodiment of the present invention. Note that the flowcharts provided herein are not necessarily indicative of the serialization of operations being performed in an embodiment of the present invention. Some steps disclosed in these flowcharts may be performed in parallel. The flowcharts are meant to designate those considerations that may be performed to produce the operations available to provide queue order information to patrons of a provider of a service in which the capacity to provide the service is exceeded by the demand. It is further noted that the order presented is illustrative and does not necessarily imply that the steps must be performed in the order shown. Additionally, it would be recognized by those of ordinary skill in the art, that some steps may be bypassed depending on the mode of communication between the service provider host, such as host 102, FIG. 1 and the patron's device. For example, it would be appreciated by artisans of ordinary skill that the communication link in a provider supplied patron alerting device such as that described hereinabove typically may be a simplex channel, and accordingly the patron cannot return information back to the service provider host. Thus, in step 201, if the communication channel is a simplex channel, steps 202, 204 and 206 are bypassed.

In step 202, a queue entry request is received, which may be in the form of patron-supplied personal contact data. This may include an identifier, typically a name of the party, and, depending on the patron's contact device, contact information such as an e-mail address or cell phone number. The patron may also indicate a number of persons in the patron's party. Additionally, the user may specify a notification criterion. These may include, for example, specifying a position in the queue at which point the patron would be notified, a notification time interval, each time the patron moves up in the queue, etc. Additionally, the patron may, in an embodiment of the present invention select additional notification information, such as a current position in the queue. Depending on the patron's communication device, the user supplied information may be provided in an e-mail, if the patron is remotely located, for example, and if queue reservations are accepted via e-mail. (It would be appreciated by artisans of ordinary skill that the network connected communication channels are duplex channels.) Alternatively, the patron may be physically present in the establishment and the information entered by an employee of the service provider. Another alternative, may be a service provider's web page, such as a web page deployed on a web server posted by an ISP (e.g., ISP 121 in architecture 100, FIG. 1). In such an embodiment, the patron may be sent a message to supply the notification criterion (or criteria), which may be presented as a web form page, and may, for example, offer the user a selection of options, step 204. In step 206, the patron's notification criterion is received, and in step 208 the patron is inserted in the queue. Alternatively, if in step 201, the channel is a simplex channel as may be used in a provider supplied patron alert, in step 207 the user (i.e., service provider) selects the notification criteria, which may be responsive to a verbal query of the patron. Criteria may include, as before, a notification time interval, a queue position, change in queue position, etc. The particular notification criteria do not implicate the present inventive principles, and any such criteria would be understood by artisans of ordinary skill to fall within the spirit and scope of the present invention.

If, in step 210, a time interval is specified (step 206), a timer associated with the particular patron's entry in the queue is started, step 212. Otherwise, step 212 is bypassed.

In step 214, an “event” loop is entered for updating the patron's position in the queue and providing the requested notifications while the patron is enqueued. If, in step 216, the patron at the head of the queue is served, in step 218 the position of the patron in the queue is updated, step 218. If, however, in step 216 the patron at the head of the queue has not been served, process 200 proceeds to step 236 (See FIG. 2C) to provide queue order information to the patron, discussed further hereinbelow. Returning, again to step 218, patron's position in a queue may be updated, for example, in an embodiment in which the queue is maintained in a spreadsheet by deleting the spreadsheet entry, that is row, from the spreadsheet. The spreadsheet application automatically adjusts the row numbers of the remaining entries whereby each member of the queue has its position “moved up” by one.

In step 220, the position of the patron in the queue is determined. Again, in an exemplary embodiment in which the queue is maintained in the spreadsheet, this may be performed by inspecting the row number of the entry corresponding to the patron. If, in step 222, the patron is at the head of the queue, e.g. row number one, in step 224 it is determined if the party may be accommodated. (Recall that the patron's party may have more members than just the patron.) This may be, in typical situations, determined by the service provider, and indicated to process 200 by a manual input entry by the service provider deleting the patron's queue entry. In step 226, the patron is notified using the contact information supplied by the patron.

In step 228 a response timer having a preselected time interval is started. In this way, patrons may be afforded an interval of time during which their opportunity for service is held open. This permits patrons to leave the immediate vicinity of the service provider's locale without forfeiting their opportunity to receive the services they seek. The time interval may be established by the particular service provider and would be understood to be different across different venues. For example, it may be reasonable for a restaurant to hold a patron's table open for, say ten minutes based on the expectations of typical restaurant patrons while a shorter interval, say three minutes, may represent the extent of the tolerance of the patrons remaining in the queue if the venue is a government services provider such as an IRS customer service window.

If, in step 230, the patron responds to the notification before the time interval elapses, the patron is dequeued in step 234 and process 200 returns to step 214. In step 214, the patron is dequeued and therefore process 200 breaks out of the loop via the “false” path in block 214 and terminates in step 244. If, however, in step 230 the patron does not timely respond, the patron is removed to the end of the queue in step 232 (or, alternatively, to another position within the queue, such as one behind the next patron).

Recall that the queued patron may represent a party of more than one person. Thus, returning to step 224, if, when patron reaches the head of the queue, the patron's party cannot be accommodated, the patron's queue position is swapped with the next patron in the queue, step 225 and process 200 proceeds to step 236 to provide notification of the patron's progress through the queue.

Steps 236-240 provide a mechanism for patrons to monitor their progress through the queue. In step 236, it is determined if the notification criterion is satisfied. That is, if the patron's current position is within a specified number of positions from the head of the queue, or if a temporal notification interval has elapsed, etc. depending on the patron's selection as previously discussed. If the criterion is not satisfied, process 200 returns to step 214 to continue to update the patron's position as the queue advances and provide notifications with respect to the patron's order in the queue.

Conversely, if the criterion is satisfied, in step 238, an estimate of the time remaining before the patron can be served as made. The time may be estimated, for example by a linear extrapolation, based on the rate at which patrons have been served between the current time and the time of the last notification to the patron. It would be appreciated by those of ordinary skill in the art that such a linear extrapolation may be a sufficient approximation to the delays experienced by the patrons in the queue in typical service provider queue environments in which the rate at which patrons are served is reasonably uniform over the typical wait time for the patrons. In other words, the circumstances that determine the rate at which patrons are served are expected to be reasonably uniform for any particular venue such as a restaurant, although the rates may differ across venues. Additionally, within a particular venue, the estimates may be adjusted by maintaining historical data to compensate for different situations that may arise. For example, a rate at which a restaurant may service its patrons at the Saturday evening dinner seating may be different than the typical rate for a weekday lunch seating. Likewise, holidays may also give rise to historically adjusted rates, and the estimates calculated in step 238 may be adjusted accordingly. Also, if the size of the patron's party requires special accommodations, a large seating for example, corresponding historical data may also be used to adjust the time estimate. In step 240, the time estimate is transmitted to the patron using the patron's contact information supplied by the patron when entered into the queue. Note that additional information may be provided, such as the patron's position in the queue. Moreover, it would be appreciated by those of ordinary skill in the art, that the information, such as the remaining time, or queue position may, alternatively, be selectable by the patron. As previously described, this information may be patron selectable, by, for example, a web page form, e-mail message or similar mechanism, as would be recognized by persons of ordinary skill in the art.

After sending the queue order information to the patron, process 200 returns to step 214 and continues to loop, updating the position of the patron in the queue and sending for their notifications until the patron is dequeued and the loop terminates in step 244 as previously described.

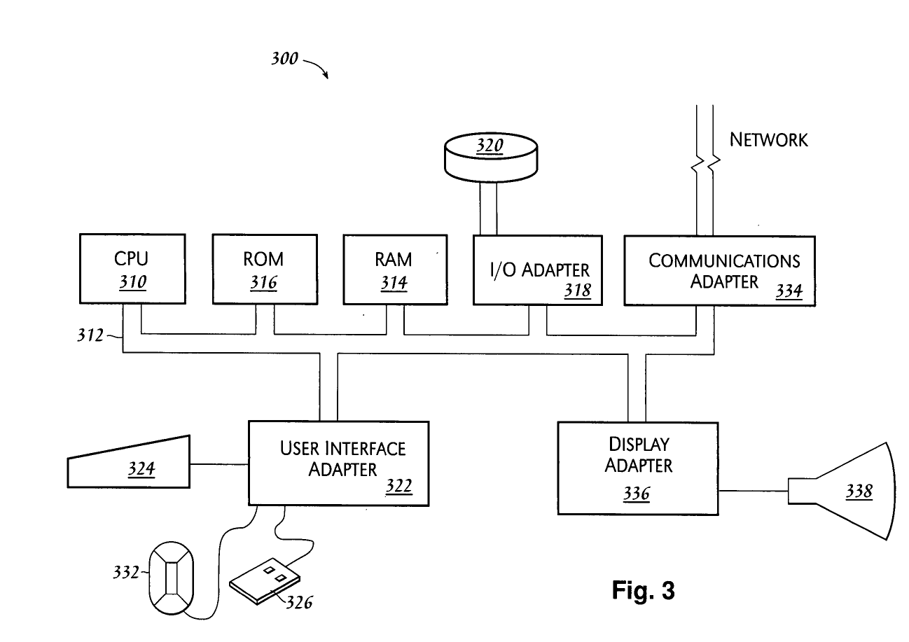

FIG. 3 illustrates an exemplary hardware configuration of data processing system 300 in accordance with the subject invention. The system in conjunction with the methodologies illustrated in FIGS. 2A-2C may be used to provide queue order notifications to patrons of a service provider in accordance with the present inventive principles. Data processing system 300 includes central processing unit (CPU) 310, such as a conventional microprocessor, and a number of other units interconnected via system bus 312. Data processing system 300 also includes random access memory (RAM) 314, read only memory (ROM) 316 and input/output (I/O) adapter 318 for connecting peripheral devices such as disk units 320 to bus 312, user interface adapter 322 for connecting queue board 324, mouse 326, trackball 332 and/or other user interface devices such as a touch screen device (not shown) to bus 312. System 300 also includes communication adapter 334 for connecting data processing system 300 to a data processing network, enabling the system to communicate with other systems, and display adapter 336 for connecting bus 312 to display device 338. CPU 310 may include other circuitry not shown herein, which will include circuitry commonly found within a microprocessor, e.g. execution units, bus interface units, arithmetic logic units, etc. CPU 310 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 314 of one or more computer systems configured generally as described above. These sets of instructions, in conjunction with system components that execute them may generate queue order information and send this to patrons waiting for service from a service provider as described hereinabove. Until required by the computer system, the set of instructions may be stored as a computer program product in another computer memory, for example, in disk drive 320 (which may include a removable memory such as an optical disk or floppy disk for eventual use in the disk drive 320). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

1. A computer implemented method for queue order notification comprising:
(a) determining a current position of a patron in a queue;
(b) determining a current estimated time remaining for said patron using the current position of the patron and a selected set of historical data; and
(c) transmitting queue order information to the patron using a preselected communication channel, and wherein, if the preselected communication channel is a duplex channel, the queue order information comprises a patron-selectable set of queue order information, the patron-selectable set including the estimated time remaining and the current position of the patron in the queue.

2. The method of claim 1 wherein the set of historical data comprises a queue servicing rate for a preceding time interval, the estimated time remaining determined using a linear extrapolation with said queue servicing rate.

3. The method of claim 2 wherein the queue servicing rate comprises a rate at which patrons have been served between a current time and a preceding notification time and wherein the set of historical data further comprises seasonal average patron service rates.

4. The method of claim 1 wherein the steps (a), (b) and (c) are repeated at a preselected notification criterion, and wherein, if the communication channel is a duplex channel, the preselected notification interval comprises a patron-selected notification criterion.

5. The method of claim 4 wherein the patron-selected notification criterion comprises one of a set including a preselected notification time interval and a preselected queue position.

6. The method of claim 1 further comprising:
(d) notifying the patron upon reaching a head of the queue using the communication channel; and
(e) if the patron fails to respond after an expiry of a predetermined time interval after step (d), moving the patron to another position within the queue.

7. The method of claim 6, wherein the another position within the queue is an end of the queue.

8. The method of claim 1 further comprising:
(d) if the patron is at the head of the queue, determining if the patron can be accommodated; and
(e) if the patron cannot be accommodated, interchanging the current position of the patron and position of a next patron in the queue.

9. A computer program product embodied in a tangible storage medium, the program product for queue order notification comprising programming instructions for:
(a) determining a current position of a patron in a queue for receiving a service from a service provider;
(b) determining, a current estimated time remaining for said patron using the current position of the patron and a selected set of historical data; and
(c) transmitting queue order information to the patron using a preselected communication channel, and wherein, if the preselected communication channel is a duplex channel, the queue order information comprises a patron-selectable set of queue-order information, the patron-selectable set including the estimated time remaining and the current position of the patron in the queue.

10. The program product of claim 9 herein the set of historical data comprises a queue servicing rate for a preceding time interval, the estimated time remaining determined using a linear extrapolation with said queue servicing rate.

11. The program product of claim 10 wherein the queue servicing rate comprises a rate at which patrons have been served between a current time and a preceding notification time and wherein the set of historical data further comprises seasonal average patron service rates.

12. The program product of claim 9 further comprising programming instructions for repeating (a), (b) and (c) at a preselected notification criterion, and wherein, if the communication channel is a duplex channel, the preselected notification interval comprises a patron-selected notification criterion.

13. The program product of claim 12 wherein the patron-selected notification criterion comprises one of a set including a preselected notification time interval and a preselected queue position.

14. The program product of claim 9 further comprising programming instructions for:
(d) notifying the patron upon reaching a head of the queue using the communication channel; and
(e) if the patron fails to respond after an expiry of a predetermined time interval after step (d), moving the patron to an end of the queue.

15. The program product of claim 14 wherein the another position within the queue is an end of the queue.

16. The program product of claim 9 further comprising programming instructions for:
(d) if the patron is at the head of the queue, determining if the patron can be accommodated; and
(e) if the patron cannot be accommodated, interchanging the current position of the patron and position of a next patron in the queue.

17. A data processing system comprising:
(a) circuitry operable for determining a current position of a patron in a queue for receiving a service from a service provider;
(b) circuitry operable for determining, a current estimated time remaining for said patron using the current position of the patron and a selected set of historical data; and
(c) circuitry operable for transmitting queue order information to the patron using a preselected communication channel, and wherein, if the preselected communication channel is a duplex channel, the queue order information comprises a patron-selectable set of queue-order information, the patron-selectable set including the estimated time remaining and the current position of the patron in the queue.

18. The data processing system of claim 17 wherein the set of historical data comprises a queue servicing rate for a preceding time interval, the estimated time remaining determined using a linear extrapolation with said queue servicing rate.

19. The data processing system of claim 18 wherein the queue servicing rate comprises a rate at which patrons have been served between a current time and a preceding notification time and wherein the set of historical data further comprises seasonal average patron service rates.

20. The data processing system of claim 17 wherein (a), (b) and (c) further comprise circuitry operable for, patron at a preselected notification criterion, repeating the operations of:
(i) determining a current position of the patron;
(ii) determining a current estimated time remaining; and
(iii) transmitting queue order information to the patron.

21. The data processing system product of claim 20 wherein the patron-selected notification criterion comprises one of a set including a preselected notification time interval and a preselected queue position.

22. The data processing system of claim 17 further comprising:
(d) circuitry operable for notifying the patron upon reaching a head of the queue using the communication channel; and
(e) circuitry operable for, if the patron fails to respond after an expiry of a predetermined time interval the operation in (d), moving the patron to an end of the queue.

23. The data processing system of claim 22 wherein the another position within the queue is an end of the queue.

24. The data processing system of claim 17 further comprising:
(d) circuitry operable for, if the patron is at the head of the queue, determining if the patron can be accommodated; and
(e) circuitry operable for, if the patron cannot be accommodated, interchanging the current position of the patron and position of a next patron in the queue.
